(19) United States
(12) Patent Application Publication
(10) Pub. No.: US 2022/0322878 A1
(43) Pub. Date: Oct. 13, 2022

(54) Digital Gas Grill Controller

(71) Applicants: Jonathan Barnes, Itasca, IL (US); Matthew Leonard, Itasca, IL (US); Aaron Rachelson, Itasca, IL (US)

(72) Inventors: Jonathan Barnes, Itasca, IL (US); Matthew Leonard, Itasca, IL (US); Aaron Rachelson, Itasca, IL (US)

(21) Appl. No.: 17/678,290

(22) Filed: Feb. 23, 2022

Related U.S. Application Data
(60) Provisional application No. 63/171,759, filed on Apr. 7, 2021.

(51) Int. Cl. A47J 37/07

(52) U.S. Cl. CPC A47J 37/0786; A47J 37/0713; A47J 2202/00

(57) ABSTRACT

An outdoor grill has a processor and remote-controlled valves (electronic or digital) whereby the processor directs gas flow to at least one burner below a grate. Sensors can be utilized to maintain temperature at the grate. A meat probe can be used to provide input to the processor to reduce temperature upon reaching a predetermined value. The processor may wirelessly communicate with a portable computing device for remote control or monitoring of status.

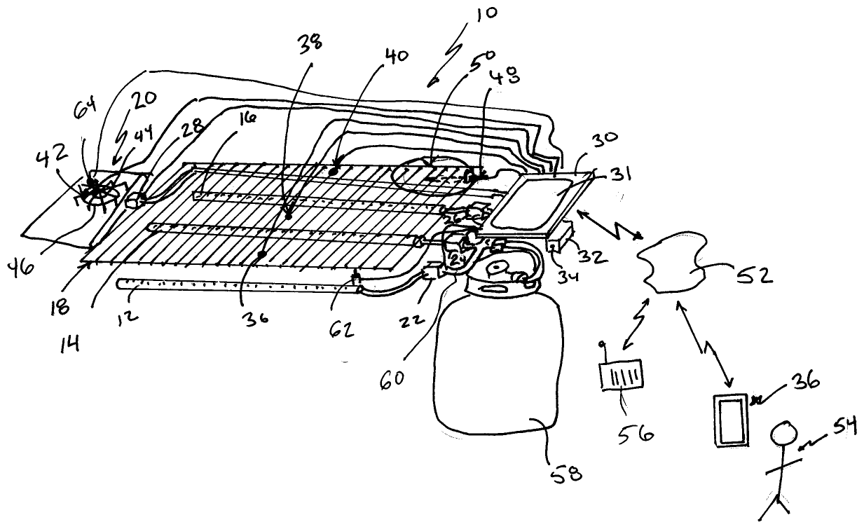

### CLAIM OF PRIORITY

This application claims the benefit of U.S. Provisional Patent Application No. 63/171,759 filed Apr. 7, 2021, which is incorporated herein by reference in its entirety.

### FIELD OF THE INVENTION

The present invention relates to grills and more particularly to electric grills or outdoor gas barbeque grills having a controller and electronic valves and more particularly to a digital grill controller for use in controlling various aspects of an outdoor barbeque grill whether it be gas or electric.

### BACKGROUND OF THE INVENTION

Gas grills traditionally have manual valves to control the flame height of a gas grill relative to a cooking surface of a gas grill.

Wood pellet smokers on the market today have electronic controls and even cooperate via smartphone apps to provide various functions. Pellet smokers have advanced features over gas grills on today's market.

Presently there are no electronically or remotely controlled gas valves on gas barbeque grills known to the applicant, and no processors to alter operation of a gas grill other than manually operated valves.

### SUMMARY OF THE INVENTION

It is an object of many embodiments of the present invention to provide an electronic valve operated and/or controlled gas barbeque grill.

It is another object of many embodiments of the present invention to provide an improved gas barbeque grill capable of controlling burner operation based on grill grate temperature or other temperature in the grills, such as to increase or decrease gas flow electronically.

It is another object of many embodiments of the present invention to provide an improved a modulating gas valve with control of the BTU output from low to high settings and/or by desired grill grate temperature, preferably with feedback.

It is another object of many embodiments of the present invention to provide timer functions to the grill to either shut off, reduce grill temperature, or reduce BTU output after a set time.

It is another object of many embodiments of the present invention to provide a meat probe capability to the grill to either shut off or dial back the grill temperature upon reaching a specific meat probe temperature.

It is another object of many embodiments of the present invention to provide remote application functions via Bluetooth, Wi-Fi, etc., to shut off or adjust grill temperature once it has been activated.

It is another object of many embodiments of the present invention to provide recipes such as cooking profiles via the app for the user to create a custom profile to grill according to specific procedures such as grilling high for three minutes, medium for five minutes, and then low for twenty minutes, etc. A temperature probe may also be employed for some embodiments, possibly with, or in lieu of time, to advance a recipe.

It is another object of many embodiments of the present invention to provide a battery powered operation and electronic control preferably independently of 120 volt AC to operate. The battery could be rechargeable, possibly by plugging the grill into an outlet or the battery into a battery charger to recharge.

It is another object of many embodiments of the present invention to provide delayed start operation of the grill to start at a specific time of day or after a timer delay.

It is another object of many embodiments of the present invention to provide electronic turn off of certain portions of the burners of the grill that are not being utilized.

Still other functions of a smart gas grill may be discovered through the implementation of electronically controlled valves.

Accordingly, a presently preferred embodiment of the present invention provides a plurality of electronic controlled valves respectively coupled to specific burners in a gas grill. Each of the valves receives a control signal preferably from a processor or controller which may be in communication with one or more sensors so that after the grill is lit the processor may attempt to maintain a specific temperature at the grill grate and/or provide for other features.

A gas valve may provide a single or multiple stages such as a simmer stage and a main burner stage such as when a main burner is on its lowest or other setting as to control BTU output (or flame height, gas flow, temperature on or at grill grate, or other grill related conditions related to temperature. There could also be three stages: low, medium, high, and/or other flame stages achieved with the gas valve. Four or other number of flame stages could also be provided depending upon the embodiment.

Instead of being powered by 120 volt AC, the preferred embodiment has a battery, whether a rechargeable battery or a traditional battery, for use in powering the processor and/or electronic valves. The battery could be recharged when the unit is plugged in to AC power for some embodiments. The processor may control BTU output from low to high. The processor may provide timer functions such as to shut off the valve or reduce grill temperature after a preset time. A meat probe function can be utilized to shut off or reduce the grill temperature upon reaching a specific temperature. A remote application feature may be performed such as through Bluetooth, Wi-Fi, etc., such as by being in communication with a smartphone, tablet or other computer to provide a signal to the processor to shut off or adjust the grill temperature such as after the grill has already been activated. Cooking profiles such as recipes can be provided via the app or through the processor to create custom profiles for grilling applications such as grilling or cooking operations (like grilling on high for three minutes, medium for five minutes, and low for twenty minutes, and then potentially maintaining a warm temperature until turned off, etc.) Grilling recipes may advance based on time at a particular setting and/or meat probe temperatures. Many embodiments do not plug into external house electrical systems via a cord or other mechanism. By having electronic controls, the electronic valve can be coordinated with an igniter for a delayed start operation which could not occur with any manual based valve grill in the marketplace today. In addition to a specific start time, a timer delay may be utilized to start after a predetermined delay. The igniter(s) may be activated by the processor as well.

Additionally, a valve can turn off certain areas of the grill when not being utilized at certain points in time through sensors and/or instructed operation.

While temperature may be controlled by the grate of the grill, it also could be controlled at other locations such as a temperature internal to the grill hood, on a cooking article, and/or other portion of the grill or location relative to the grill. A manually or auto adjustable display could be utilized having contrast/brightness adjustment features.

### BRIEF DESCRIPTION OF THE DRAWINGS

The particular features and advantages of the inventions with other objects will become apparent from the following description taken in connection with the accompanying drawings in which:

The FIGURE shows a perspective view of the present preferred embodiment of the present invention.

### DETAILED DESCRIPTION OF THE PREFERRED EMBODIMENT

The FIGURE shows a presently preferred embodiment of a portion of a grill 10 incorporating improvements described herein. Specifically, instead of having manual control knobs, electronic and/or digitally control valves are employed to control gas flow to the gas burners as will be described below. When coupled with a processor, features not known with gas barbeque grills can be provided to the marketplace.

Grill 10 can be similar in the form of a traditional outdoor grill such as with longitudinal extending burners 12,14,16 and/or others, often disposed in parallel below a grill grate 18 onto which food and/or cooking articles are normally set thereupon such as hamburgers, steaks, fish, checking, pork, etc. Other grills 10 have burners 12,14,16 running in a perpendicular direction to a grill grate such as zone cooking grills. Of course, vegetables and/or other food including bread and/or other food as are often grilled across the country could be cooked on the grill 10 as well. A side burner 20 and/or others may also be utilized as is often provided with various gas grills in the marketplace. Other barbeque grills may have other configurations or features.

However, instead of using manual valves, electronically controlled valves 22,24,26 and/or 28 and/or others can be utilized with various grills. These electronic control valves 22-28 can be connected to a processor 30 to assist in controlling operation of the various valves 22-28. Specifically, the processor 30 can receive an input such as through a touchpad display 31 or other input to provide an electronic signal such as a digital signal to any of the valves 22-28 therefore causing the valves to open to a specific amount (or close) a specific desired flow whether it be off, low, medium, high and anywhere in between. A specific BTU output or other controlled flow rate through the various valves 22-28 could be provided. A battery pack 32 provides power to the processor 30 and then provides sufficient power for the signals to be provided to the various valves 22-28 to provide a desired flow. The battery 32 could be a rechargeable battery (which may be recharged either by plugging in the grill 10 or connecting the battery 32 to a battery charging unit) and/or traditional battery (aka disposable) such as are commonly sold in the marketplace. Since the only power required from the batteries is to drive the processor, the valves, and possibly igniter(s) very little energy is utilized and therefore batteries can work particularly well for this operation. A low battery indicator 34 may indicate a need to change and/or recharge the battery 32. Of course, a low battery indicator 34, if provided, could also be provided to a user's smartphone 36 of the processor 30 and/or other computer type device connected to the processor 30 or with the touchpad display 31, etc. The grill 10 could save its operation and resume if the battery pack is swapped out within a specific time period (such as 30 seconds) or if the grill 10 is plugged into an electric power source, such as AC power. When AC power is applied, the appliance may operate from the AC power source while the batteries recharge.

Some embodiments of the present invention may provide for an ability to have simmer at the various burners 12,14,16,20 while also having a main burner control based on grill grate 18 temperature as could be monitored by one or more sensors 36,38,40,42 and/or others. One or more igniter(s) 44,46 could be utilized to ignite the various burners 12,14,16,20 by the user. Simmer and main control of any of the burners 12,14,16,20 could be performed either utilizing a single flow burner 12,14,16 and/or a dual flow burner type construction such as an inner and outer flow path or inner and outer rings 44,46 of burner 20 or otherwise. A single valve 28 might be utilized to provide both of the flows at side burner 20 in such a manner. Multiple valves 28 may be used with a single burner 20 for other embodiments.

Additionally, by having the sensors 36,38,40,42 the grill grate and/or other portion of the grill may be maintained at a specific temperature by utilizing input from the sensors 36,38,40,42 back to the processor 30 so as to then to provide signals to the electronic control valves 22,24,26,28 to control the BTU output (directly or indirectly) from any of the burners 12,14,16,20. A modulating gas valve 22-28 may be controlled by a PID or other algorithm. The BTU output may adjust as the grill temperature reaches a desired setpoint.

Additionally, timer functions could be provided by the processor 30 such as to shut off at a specific time and/or after a specific time and/or dial back the grill temperature to a predetermined amount such as by reducing the flames to simmer or other setting after a predetermined of time of cooking at a specific grill grate temperature 18 or other temperature or after a specific time of cooking.

Furthermore, a meat probe 48 may be inserted into an article 50 to be cooked such as a steak or pork loin, etc. The signal from the meat probe 48 may be provided back to the processor 30 so that when a specific temperature is reached the heat output from any of the various electronic control valves 22,24,26,28 may be reduced so as to merely keep the food 50 warm as opposed to continuing to cook it and/or turned off or provide other temperature settings. This feature may add flexibility to those desiring to put something on the grill not knowing when they may actually be eating the food such as not sure whether they might eat at 6:00 or 7:00 at night. With this feature, the food could be cooked, ready and warm regardless of when taken off the grill.

Although current safety guidelines may not allow for the remote ignition of a grill, it may be possible that those rules may change over time. Some appliances have a ready mode to allow users to use remote control. By placing the grill 10 in ready mode, remote control features may be enabled. Igniters 62,64 may coordinate with electronically controlled valves 22,24,26,28 to have a delayed start time for cooking controlled by the processor 30. Remote control may be understood with reference to cloud 52 which could be Wi-Fi, Bluetooth or other protocol to communicate with a user 54 such as through a smartphone 36 which could also be a tablet, a computer, or other device remote from the processor 30. A Wi-Fi router 56 is being illustrated, but Bluetooth could be utilized so that the processor 30 may be in direct communication with the smartphone 36 or other computing device. Smartphone 36 may provide input and/or display for processor 30 for some embodiments. With such remote capability, the user 54 could remotely control the shutoff or adjust grill temperature once it's been activated and/or change it depending upon the desires of the user.

With processor 30, specific cooking profiles may be provided either remotely by the user 54 through the smartphone 36 or other computer or at the processor 30 such as to have a custom profile to grill such as grill on high for three minutes and then a medium setting for give minutes and low for twenty minutes so as to sear then cook and then warm and/or provide for other cooking profiles desired by the user 54. The meat probe 48 could also be utilized for specific grilling profiles as described above or otherwise.

Delayed start operation of the grill 10 can start at a specific time of time or after a specific delay for some embodiments.

Additionally, the processor 30 can coordinate a host of functions not previously known such as being in communication with various sensors 36,38,40,42 to sense whether or not meat is located on a specific portion of the grill grate 18 to then potentially secure specific burners in an effort to conserve energy and/or provide an ability for the user to only utilize portions of the grill expect to be utilized for particular cooking operation.

The grill 19 may resemble in looks many of the traditional grills available in the market, or not, and may have portable propane cylinder 58 having a gas supply such as propane connected to a manifold 60 which could then provide gas to the various electronic control valves 22,24,26,28. Natural gas could be used with grills 10 for some embodiments.

Numerous alterations of the structure herein disclosed will present themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having set forth the nature of the invention, what is claimed herein is:

What is claimed is:

1. A gas outdoor cooking grill comprising:
at least one valve selected from the group of digitally and electronically controlled,
said at least one valve controlling gas flow to at least one burner located below at least one cooking grate;
a processor in communication with the at least one valve directing operation of the at least one valve.

2. The gas outdoor cooking grill of claim 1 further comprising an input device in the form of a touchpad display receiving user input to direct gas flow to the at least one burner.

3. The gas outdoor cooking grill of claim 2 wherein the touchpad display provides an ability to direct a specified BTU to the at least one burner.

4. The gas outdoor cooking grill of claim 1 further comprising a battery pack providing power for the processor and at least one valve.

5. The outdoor cooking grill of claim 4 further comprising a low battery indicator.

6. The outdoor cooking grill of claim 1 wherein the processor communicates wirelessly with a portable computing device of a user selected from the group of a tablet, a smartphone and a computer, wherein the portable computing device provides input to the processor to control gas flow to the at least one burner.

7. The outdoor cooking grill of claim 6 wherein the portable computing device of the user has a display displaying a status of the outdoor cooking grill.

8. The outdoor cooking grill of claim 1 wherein the at least one valve comprises multiple valves directing multiple gas flows to a single burner.

9. The outdoor cooking grill of claim 1 further comprising one or more sensors providing input to the processor.

10. The outdoor cooking grill of claim 9 wherein the one or more sensors further comprises a meat probe.

11. The outdoor cooking grill of claim 10 wherein upon reaching a predetermined temperature at the meat probe, the processor reduces gas flow to the at least one burner to reduce temperature below the at least one grate.

12. The outdoor cooking grill of claim 10 wherein the processor directs temperature at the at least one grate employing feedback from the one or more sensors.

13. The cooking grill of claim 10 further comprising a cooking profile directed by the processor providing different temperatures at the at least one grate for specified periods of time.

14. The cooking grill of claim 13 providing a cooking profile comprising a seer temperature for a first period of time, followed by a cook temperature less than the seer temperature for a second period of time, followed by a warm temperature less than the cook temperature.

15. The cooking grill of claim 9 wherein the based on input from the one or more sensors, the processor determines at least one area of the grate having no food thereon and securing flow to at least one of the at least one burner to conserve energy.

16. The cooking grill of claim 1 further comprising a timing function whereby the processor shuts of gas flow to the at least one burner under certain situations.

17. The cooking grill of claim 1 further comprising a timing function whereby the processor reduces gas flow to the at least one burner under certain situations.

18. The cooking grill of claim 1 wherein the processor directs ignition of grill at a specific time.
